(19) United States
(12) Patent Application Publication
(10) Pub. No.: US 2017/0298270 A1
(43) Pub. Date: Oct. 19, 2017

(54) ENVIRONMENTAL GELLING AGENT FOR GRAVEL PACKING FLUIDS

(71) Applicant: Schlumberger Technology Corporation, Sugar Land, TX (US)

(72) Inventors: Nikhil SHINDGIKAR, Aberdeen (GB); Carlos ABAD, Aberdeen (GB)

(21) Appl. No.: 15/099,144

(22) Filed: Apr. 14, 2016

(51) Int. Cl. C09K 8/90; E21B 43/16; E21B 43/04

(52) U.S. Cl. CPC C09K 8/90; E21B 43/04; E21B 43/16

(57) ABSTRACT

A method of treating a subterranean formation penetrated by a wellbore, the method comprising pumping a wellbore fluid into the wellbore, the wellbore fluid comprising an aqueous base fluid and an environmentally friendly slurried gelling agent meeting at least two of the following three criteria: (1) Biodegradation: a) >60% in 28 days as measured by OECD 306 or any other OSPAR-accepted marine protocols, b) or in the absence of valid results for such tests: i. >60% in 28 days as measured by OECD 301B, 301C, 301D, 301F, 310, Freshwater BODIS or ii. >70% in 28 days as measured by OECD 301A, 301E); (2) Bioaccumulation: a) a bioconcentration factor of less than 100; b) log P_{ow}≦3 and molecular weight >700, or c) if the conclusion of a weight of evidence expert judgment under Appendix 3 of OSPAR Agreement 2008-5 is positive; and (3) Aquatic Toxicity: a) LC₅₀>10 mg/l or EC₅₀>10 mg/l and performing a downhole operation.

### BACKGROUND

Hydrocarbons (oil, natural gas, etc.) are obtained from subterranean geologic formations (“reservoirs”) by drilling wells that penetrate the hydrocarbon-bearing formations. During the drilling of a wellbore, various fluids are typically used in the well for a variety of functions. The fluids may be circulated through a drill pipe and drill bit into the wellbore, and then may subsequently flow upward through wellbore to the surface. During this circulation, a drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

Once drilling operations have been completed, the well is prepared for the completion operations (such as placement of a gravel pack in the wellbore) whereby the mud used for drilling is often displaced by a completion fluid. A completion operation involves the design, selection and installation of equipment and materials in or around the wellbore for conveying, pumping or controlling the production or injection of fluids. After the well has been completed, production of oil and gas can begin.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of treating a subterranean formation penetrated by a wellbore that includes pumping a wellbore fluid into the wellbore, the wellbore fluid including an aqueous base fluid and an environmentally friendly slurried gelling agent meeting at least two of the following three criteria: (1) Biodegradation: a) >60% in 28 days as measured by OECD 306 or any other OSPAR-accepted marine protocols, or b) in the absence of valid results for such tests: i. >60% in 28 days as measured by OECD 301B, 301C, 301D, 301F, 310, Freshwater BODIS or ii. >70% in 28 days as measured by OECD 301A, 301E; (2) Bioaccumulation: a) a bioconcentration factor of less than 100; b) log Pow≦3 and molecular weight>700, or c) if the conclusion of a weight of evidence expert judgment under Appendix 3 of OSPAR Agreement 2008-5 is positive; and (3) Aquatic Toxicity: a) LC50>10 mg/l or EC50>10 mg/l, and performing a downhole operation.

In another aspect, embodiments of the present disclosure relate to a method of treating a subterranean formation penetrated by a wellbore that includes pumping a wellbore fluid into the wellbore, the wellbore fluid including an aqueous base fluid, gravel and a slurried gelling agent including at least a gelling agent dispersed in a mixture of polyethylene glycol and glycerin and treating the subterranean formation while the wellbore fluid is in the wellbore.

In yet another aspect, embodiments of the present disclosure relate to an environmentally friendly slurried gelling agent chemical composition that includes at least a gelling agent dispersed in a solvent with a stabilizer, wherein each of the gelling agent, the solvent and the stabilizer are environmentally friendly, meeting at least two of the following three criteria: (1) Biodegradation: a) >60% in 28 days as measured by OECD 306 or any other OSPAR-accepted marine protocols, b) or in the absence of valid results for such tests: i. >60% in 28 days as measured by OECD 301B, 301C, 301D, 301F, 310, Freshwater BODIS or ii. >70% in 28 days as measured by OECD 301A, 301E; (2) Bioaccumulation: a) a bioconcentration factor of less than 100; b) log Pow≦3 and molecular weight>700, or c) if the conclusion of a weight of evidence expert judgment under Appendix 3 of OSPAR Agreement 2008-5 is positive; and (3) Aquatic Toxicity: LC50>10 mg/l or EC50>10 mg/l.

Other aspects and advantages of the claimed subject matter will be apparent from the following description and the appended claims.

### BRIEF DESCRIPTION OF DRAWINGS

FIG. 1 shows viscosity versus shear rate for a conventional linear gel.

FIG. 2 shows viscosity versus shear rate for a linear gel according to the present embodiments.

FIG. 3 shows the break profile of various gels.

FIG. 4 shows viscosity versus shear rate for a conventional linear gel.

FIG. 5 shows viscosity versus shear rate for a linear gel according to the present embodiments.

FIGS. 6 to 10 show the break profile of various gels.

### DETAILED DESCRIPTION

At the outset, it should be noted that in the development of any such actual embodiments, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the compositions used/disclosed herein may also comprise some components other than those cited. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

Generally, embodiments disclosed herein relate to wellbore fluids including environmentally friendly gelling agents and methods of using the same. More specifically, embodiments disclosed herein relate to wellbore fluids for downhole applications formed of an aqueous base fluid and an environmentally friendly slurried gelling agent. The inventors of the present disclosure have found that the environmentally friendly slurried gelling agents as described herein may exhibit an unexpected improvement in the rheology, while maintaining a favorable environmental rating in the North Sea. Specifically, an acceptable rheological profile may be achieved by dispersing a lower active concentration of a gelling agent in a mixture of an environmentally friendly solvent, as compared to conventionally environmentally unfriendly slurried gelling agents.

As used herein, the term “gelling agent” is defined as a solid polymer based material that when properly dispersed in an aqueous solvent or brine, such polymer may be fully dissolved, and serves as a means to substantially increase the viscosity of the aqueous solvent or brine.

As used herein, the term “slurried gelling agent” is defined as a pumpable chemical composition including at least a polymer based gelling agent dispersed in an organic solvent in which the gelling agent exhibits minimal solubility, and in some embodiments, a minor concentration of a second polymer that may enhance the polymer suspension in the solvent.

As used herein, the term “aqueous wellbore fluid” is defined as a pumpable aqueous fluid comprising an aqueous solvent or brine, and which has been viscosified by means of the addition and dissolution of a given concentration of a slurried gelling agent composition.

As used herein, the term “aqueous gravel pack pad fluid” is defined as a pumpable aqueous wellbore fluid which has been viscosified by means of the addition and dissolution of a given concentration of a slurried gelling agent composition to an aqueous brine, and which is used in a gravel packing treatment as a first fluid to displace the completion brine.

As used herein, the term “slurry aqueous wellbore fluid” is defined as a pumpable aqueous wellbore fluid which has been viscosified by means of the addition and dissolution of a given concentration of a slurried gelling agent composition to an aqueous brine, and contains a given concentration of solid particulates (gravel or proppant) which is used in a gravel packing treatment as a second fluid displacing the aqueous gravel pack pad fluid, and to deposit the transported gravel in the annular space between wellbore and screen.

As used herein, the term “environmentally friendly” is defined as chemicals or formulations that can pass the most stringent environmental testing criteria as described below. Furthermore, as used herein, the term “environmentally unfriendly” is defined as chemicals or formulations that do not pass the most stringent environmental testing criteria. Specifically, one of the measures of sample toxicological test is marine biodegradation on a component level as outlined in the Organization for Economic Cooperation and Development, Procedure OECD 306 or BODIS. In the North Sea offshore environment, OSPAR prescreening scheme is followed to determine if a substance would be a candidate for “substitution warning” classification (i.e., chemical substances identified as candidates for substitution). The ecotoxicity test requirements are: bioaccumulation, biodegradation in sea water or fresh water, and toxicity testing on specific North Sea species such as Skeletonema costatum, Acartia tonsa, and juvenile turbot. In order for a chemical to be used without any implications offshore in the North Sea it must satisfy two of the following three criteria:
1) Biodegradation: >60% in 28 days as measured by OECD 306 or any other OSPAR-accepted marine protocols, or in the absence of valid results for such tests, >60% in 28 days as measured by OECD 301B, 301C, 301D, 301F, 310, Freshwater BODIS or >70% in 28 days as measured by OECD 301A, 301E;
2) Bioaccumulation: a bioconcentration factor (BCF)<100 determined according to OECD 305 or ASTM E 1022 guidelines, or log Pow (partition coefficient of a substance between N-octanol and water, measured or calculated according to the HOCNF Guidelines or an OECD 107 test) ≦3 and molecular weight >700, or if the conclusion of a weight of evidence expert judgment under Appendix 3 of OSPAR Agreement 2008-5 is positive; and
3) Aquatic Toxicity: LC50>10 mg/l or EC50>10 mg/l; if toxicity values>10 mg/l are derived from limit tests to fish, actual fish LC50 data should be submitted in accordance with OSPAR Guidelines for Completing the HOCNF. In particular embodiments, each of the three criteria are met.

At present (and for the last 30 years), the geographic location with the most stringent environmental and discharge testing criteria for well treatment operation is the North Sea, but the definition of either of these terms should in no way be limited to any past, present or future North Sea environmental testing criteria. Further, the test criteria also in no way limit the geographical region of use of the fluid, but provide an indication of the environmental friendliness of a product (or fluid containing a product).

As solutions are found useful to provide certain functions in treatment fluids, when used in the North Sea off shore, or other highly regulated off shore environments, stringent requirements for particular off shore environments are met. Any oilfield chemical that is used in the North Sea is registered with the respective country's regulatory body which assigns a rating or color classification to each chemical depending on its environmental and toxicological characteristics. Based on the chemical rating or color classification, the chemical will either be regarded as more or less environmentally friendly or unfriendly. In the North Sea, the classification techniques vary. For example, Norway and Denmark follow color classification for chemical products, United Kingdom (UK) follows color and letter ratings for organic and inorganic chemical products, respectively, and Netherlands follows letter categories. Thus, countries within a small geographic region have customized their classification system based upon a desire to differentiate environmentally friendly and unfriendly chemical products. Regardless of the classification system, each of the North Sea countries (Norway, Denmark, Netherlands and United Kingdom) employs the same three ecotoxicology tests criteria described above to differentiate chemical products.

When each component in a chemical product passes the above mentioned criteria, then typically the whole product can be termed as “Green” or PLONOR (Pose Little Or NO Risk) in Norway and Denmark. When all the components in a product meets two of the criteria, then the product can receive “Yellow” classification in Norway and Denmark, and still considered as environmentally friendly. If the biodegradation value in seawater or fresh eater is <20% after 28 days for any of the components or if toxicity (LC50 or EC50) of an inorganic component is less than 1 mg/L, then the chemical products can receive “Red” classification or substitution warning (i.e., environmentally unfriendly classification in the North Sea). Table 1, below, summarizes the North Sea regulations. As a rule of thumb, two or more “Good” results means that the chemical compounds are acceptable, while two or more “Bad” results means that the chemical compound is unacceptable. However, a chemical compound having less than 20% biodegradation alone or an LC50 or EC50 of less than 1 mg/L may end up with environmentally unfriendly classification in the North Sea and could be unacceptable.

TABLE 1
North Sea Regulations Interpretation

| | Test | | | | | | | |
|---|---|---|---|---|---|---|---|---|
| | Biodegradation | | | Bioaccumulation | | Toxicity - EC/LC50 | | |
| | Unit | | | | | | | |
| | % | | | Log Pow | | mg/L | | |
| | Result | | | | | | | |
| | <20 | 20-60 | >60 | <3 | >3 | <1 | <10 | >10 |
| Inference | Very | Bad | Good | Good | Bad | Very | Bad | Good |
| | bad | | | | | bad | | |

Depending on the service performed, a well service operation may involve a large amount of chemicals, which means that the introduction of environmentally friendly chemicals is mandatory. While gravel packing operations used for the production of hydrocarbons from unconsolidated formations are planned to ensure zero discharge of fluids and chemicals to the sea bed, nonetheless, authorities, operators, service providers and chemical manufactures strive to continuously improve the environmental profile of the chemical products utilized in wellbore intervention operations to ensure that in the eventual case of an accidental discharge, the chemical products involved in the treatment are as benign to the environmental as feasibly possible. Embodiments of the present disclosure provide a slurried gelling agent that may meet the stringent criteria discussed above.

According to the present embodiments, the wellbore fluids of the present disclosure include an environmentally friendly slurried gelling agent. That is, the gelling agents of the present disclosure may be delivered in a liquid form as a slurry. The gelling agent may act as a viscosifier that increases the viscosity of the fluids into which they are dispersed, to enhance the ability of the wellbore fluids to suspend sand or other particulate material. The use of slurried gelling agents may also encompass certain operational advantages mainly related to the easiness of metering the appropriate concentrations. It may also ease the chemical transportation and usage in the offshore environment. In addition, according to various embodiments, the gelling agents used for the formulation of wellbore fluids of the present disclosure may exhibit the following properties: a) are environmentally friendly and b) do not or minimally interact with the base fluid and other components of the wellbore fluid. Further, advantageously and unexpectedly, the gelling agents, when combined with environmentally friendly solvents, are able to achieve the desired rheological profile at a lower polymer loading than what is conventionally needed for environmentally unfriendly solvents.

According to the present embodiments, the slurried gelling agents may be formulated by dispersing at least a gelling agent in an environmentally friendly solvent and an optional stabilizer in an amount sufficient to provide a desired viscosity to the slurried gelling agent. For example, in various embodiments, the gelling agent may be present in the environmentally friendly slurried gelling agent in an amount that ranges from about 30 wt % to 50 wt %, from about 32 wt % to 48 wt %, from about 35 wt % to 46 wt %, from about 36 wt % to 44 wt %, from about 37 wt % to 42 wt %, or from about 38 wt % to about 40 wt % of the total weight of the slurried gelling agent, where the lower limit can be any of 30 wt %, 32 wt %, 35 wt %, 36 wt %, 37 wt %, 38 wt %, 38.4 wt %, 38.6 wt % or 38.8 wt % and the upper limit can be any of 39 wt %, 39.6 wt %, 39.8 wt %, 40 wt %, 42 wt %, 44 wt %, 46 wt %, 48 wt %, or 50 wt %, where any lower limit can be used with any upper limit. Lower and upper limits for the concentration of the gelling agent in the environmentally friendly slurried gelling agent may be determined by economical and technical reasons. Lower limits for the polymer concentration may be determined based on additive stability reasons (too low concentration will render the slurry difficult to stabilize, and its shelf life will be likely too short with substantial solids settling being possible), and transport reasons (the lower the gelling agent concentration, and the higher the environmentally friendly solvent, the higher the transport cost). Upper limits for the concentration of the gelling agent in the environmentally friendly slurried gelling agent may be determined based on additive pump ability reasons (too high concentration will render too viscous and the slurry may be difficult to pump).

Examples of gelling agents are polysaccharides that when hydrated and at a sufficient concentration are capable of forming a viscous solution. Some nonlimiting examples of suitable polymers useful as gelling agents in the fluids of the present disclosure include water soluble biopolymers like those polysaccharides of bacterial or fungal origin such as xanthan gum, diutan gum, wellan gum, gellan gum, scleroglucan, schizophyllan; natural polysaccharides of plant origin such as starch, natural galactomannans like fenugreek gum, tara gum, locust bean gum, carob gum, konjac gum, guar gum, or synthetically modified guar derivatives such as hydroxypropyl guar (HPG), carboxymethyl guar (CMG), and carboxymethylhydroxypropyl guar (CMHPG); cellulose derivatives such as carboxymethylcellulose (CMC) hydroxyethylcellulose (HEC) or hydroxypropylcellulose (HPC) and carboxymethylhydroxyethylcellulose (CMHEC) may also be used. Any useful polymer may be used in either crosslinked form, or without crosslinker in linear form. The environmentally friendly polymers as described herein may generate in aqueous solution a substantial yield stress at low temperatures (such as ambient temperatures observed during oilfield operations in different areas of the world, and seasons, such as between 5° C. and 45° C.), and may maintain such yield stress up to high temperatures such as those encountered in downhole reservoirs. As it will be described later, in more detail, aqueous base fluids may be selected from the group of fresh water, sea water, or densified brines such as sodium chloride, sodium bromide, potassium chloride, potassium bromide, calcium chloride, calcium bromide, sodium formate, potassium formate, cesium formate, and the like and mixtures thereof at specific gravities between 1.0 SG (specific gravity) and 2.3 SG referred to water at 20° C. and 1 atm. The environmentally friendly polymers that have shown particular utility in the present disclosure may be selected from the group of xanthan gum, wellan gum, gellan gum, and diutan gum. For example, xanthan, diutan, or welan gums may provide improved sand transport properties, long-lasting viscosity, effective mud cleaning and displacement properties, moderate emulsion tendency with oils, crudes, and oil based muds, good retained sand pack permeability, gravel pack permeability, and formation permeability, as well as efficient breaking properties to a wellbore fluid in which it is used for various fluids at various densities and temperatures of use. Xanthan gums are hydrophilic polysaccharides which are obtained by the fermentation of appropriate nutrient media with microorganisms of the genus Xanthomonas. When dissolved in water in low concentration, xanthan gums impart a viscosity to the aqueous solution. The resulting viscosified solutions are used in a wide variety of industrial applications, such as in the manufacture of ingestible products, such as food products (e.g., sauces, ice creams, etc.), and in oil field drilling fluids. Xanthan viscosified solutions are particularly useful in applications where it is desirable to suspend solid materials in the aqueous medium. During commercial preparation of most xanthan gums, the solid xanthan is recovered by precipitation from the fermentation broth in which it is made. Generally, it is not feasible to separate all extraneous fermentation solids before this precipitation stage, so that the dried solid xanthan gum recovered in this manner normally contains some water insoluble solids, such as nonviable bacterial cells and other cellular debris. These solids, of course, do not dissolve when xanthan is re-dissolved in water. While the presence of these solids is not objectionable in many cases, it may be problematic in compositions or applications where a completely clear viscosified solution is desired.

For applications disclosed herein, diutan gum, xanthan gum, and a clarified xanthan gum product may be used. Such applications include, but are not limited to, viscosified gravel packing treatments following water based or oil based mud drilling of open holes, comprising amongst others the fluid pumping stage of open hole mud conditioning, open hole mud displacement and removal, pumping spacer fluid between mud and gravel pack with the purpose of separating them, gravel pack pad pumping, and gravel pack solids laden slurry placement. According to various embodiments, xanthan may be modified or unmodified. As described herein, the term “modified xanthan” is defined as a xanthan that has been treated to modify or alter the normal polymeric structure of xanthan. As described herein, a clarified xanthan refers to xanthan gum recovered by precipitation of the fermentation broth, and that has been chemically and mechanically modified resulting in minor changes to the native xanthan gum molecular weight, and chemical structure, but substantially reducing the concentration of non viscosifying extraneous fermentation solids like bacterial cell debris.

It is also envisioned that the environmentally friendly slurried gelling agent of the present disclosure may include an additional slurry stabilizer agent, such as an environmentally friendly polymer. It has been found that optimum pumpable formulations of the environmentally friendly slurried gelling agents of the present disclosure may be formulated when the concentration of the additional slurry stabilizer may range from about 0.001 wt % to about 3 wt %, from about 0.1 wt % to about 2 wt %, from about 0.2 wt % to about 1.5 wt %, or from about 0.5 wt % to about 1 wt %. In some cases, the slurry stabilizer polymer is added to ensure that the gelling agent dispersed in the environmentally friendly solvent does not substantially settle during the transport and storage following the slurry manufacture, and prior to its use at the wellsite. Settling of the environmentally friendly gelling agent may result in a reduced slurry polymer concentration, partially lost material at the bottom of the transport container, and, if not properly prevented, controlled, identified, quantified, and managed, may result in inappropriate fluid viscosity during the gravel packing treatments, and ultimate in partial packing, and failed operation. It has been found that in some solvent and gelling agent pairs, the gelling agent polymers may be self stabilizing for the slurry, whereas in some other cases of gelling agent and solvent pairs, some additional stabilizer polymers may be used to enhance the slurry stability, maintaining the gelling agent polymer in dispersion. In this case, the stabilizing polymer and the solvent may not have a deleterious effect on formulated aqueous fluid viscosity, but may eventually enhance the gravel packing and or displacement fluid viscosity. Given the benefit of this disclosure, a person of ordinary skill may identify combinations where a synergistic effect in the fluid viscosity could be even obtained through the proper choice of gelling agent, (xanthan for example), solvent and a second biopolymer, such as guar, or diutan. As described herein, the term synergy is used when the mixture of gelling agent, solvent and second biopolymer mixed at a given total polymer concentration (obtained by the addition of the respective concentrations of each of the two polymers) in the gravel packing fluid results in a viscosity exceeding that of a fluid with either of the two polymers when used at the same total polymer concentration.

It has been found that environmentally friendly slurried gelling agents as described herein are particularly useful to viscosify aqueous solvents and brines to obtain aqueous wellbore fluids, whether as batch mixed fluids and or as “on the fly” mixed fluids when their viscosity measured at a shear rate of about 170 s⁻¹ (100 rpm in a Fann 35 viscometer with a Bob 1, Rotor 1, and with a spring F1) is not lower than 15 cP and does not exceed 50 cP, where the lower limit can be any of 15 cP, 20 cP or 25 cP and the upper limit can be any of 35 cP, 38 cP, 40 cP, or 50 cP, where any lower limit can be used with any upper limit.

It is also envisioned that environmentally friendly slurried gelling agents as described herein may be used to viscosify aqueous solvents and brines to obtain aqueous wellbore fluids, whether as batch mixed fluids and or as “on the fly” mixed fluids when their viscosity measured at a shear rate of about 1000 s⁻¹ (600 rpm in a Fann 35 viscometer with a Bob 1, Rotor 1, and with a spring F1) is not lower than 5 cP and does not exceed 25 cP, where the lower limit can be any of 5 cP, 7 cP or 8 cP and the upper limit can be any of 12 cP, 14 cP, 15 cP, or 25 cP, where any lower limit can be used with any upper limit.

In various embodiments, a mixture of two or more environmentally friendly gelling agents may be used to prepare an environmentally friendly slurried gelling agent composition. For example, two or more different environmentally friendly slurried gelling agents may be added to a gravel packing fluid and mud displacement fluid for an operation, whereby the specific performance of the fluid such as viscosity, sand settling capacity, mud displacement capability, oil based mud cleaning efficiency, temperature stability, breaking ability, and retained permeability, are optimized as a function of the content of each of the two or more polymers.

As noted above, the slurried gelling agents of the present disclosure may include the gelling agent dispersed in a solvent with an optional stabilizer, wherein the gelling agent, the solvent and the stabilizer are environmentally friendly. In one or more embodiments, the environmentally friendly solvent may be present in the environmentally friendly slurried gelling agent in an amount that ranges from about 48.0 wt % to about 69.8 wt % of the total weight of the slurried gelling agent, where the lower limit can be any of 48.0 wt %, 50 wt % or 52 wt %, and the upper limit can be any of 65 wt %, 69 wt %, or 69.8 wt %, where any lower limit can be used with any upper limit. Table 2 illustrates various formulations of environmentally friendly slurried gelling agents.

Although polyols are generally suitable solvents for use with the slurried gelling agents of the present disclosure, the polyols that have shown particular utility in the present embodiments are glycerin, polyethylene glycols (PEG) and mixtures thereof In embodiments where a mixture of solvents is used, such as polyethylene glycol and glycerin, the glycerin may be present in the environmentally friendly slurried gelling agent in an amount that ranges from about 2.3 wt % to about 11.6 wt %, from about 3.3 wt % to about 10.2 wt %, from about 4.0 wt % to about 8.0 wt %, from about 4 wt % to about 7.8 wt %, or from about 5 wt % to about 7 wt % of the total weight of the slurried gelling agent, where the lower limit can be any of 2.3 wt %, 2.4 wt %, 2.5 wt % or 2.6 wt % and the upper limit can be any of 11.2 wt %, 11.3 wt %, 11.4 wt %, or 11.6 wt %, where any lower limit can be used with any upper limit. In such embodiments, the polyethylene glycol may be present in the environmentally friendly slurried gelling agent in an amount that ranges from about 40.0 wt % to about 66.5 wt % of the total weight of the slurried gelling agent, where the lower limit can be any of 40 wt %, 41 wt %, or 42 wt % and the upper limit can be any of 62 wt %, 64 wt %, or 66.5 wt %, where any lower limit can be used with any upper limit. Thus, in such embodiments, the ratio between the polyethylene glycol and the glycerin may range from about 5:1 to about 20:1, or from about 8:1 to about 11:1. This is summarized in Table 2, below.

TABLE 2
Various formulations prepared according to the present disclosure

| Gelling | | | Solvent 2 | Solvent 1 | Ratio |
|---|---|---|---|---|---|
| agent | Stabilizer | Solvent | (PEG) | (glycerol) | solvent 2: |
| (%) | (%) | (%) | (%) | (%) | solvent 1 |
| 30 | 0.2 | 69.8 | 62.0 | 7.8 | 8:1 |
| | | | 58.2 | 11.6 | 5:1 |
| | | | 64.0 | 5.8 | 11:1 |
| | | | 66.5 | 3.3 | 20:1 |
| 50 | 2 | 48 | 42.7 | 5.3 | 8:1 |
| | | | 40.0 | 8.0 | 5:1 |
| | | | 44.0 | 4.0 | 11:1 |
| | | | 45.7 | 2.3 | 20:1 |
| 38 | 0.75 | 61.25 | 54.4 | 6.8 | 8:1 |
| | | | 51.0 | 10.2 | 5:1 |
| | | | 56.1 | 5.1 | 11:1 |
| | | | 58.3 | 2.9 | 20:1 |
| 40 | 0.75 | 59.25 | 52.7 | 6.6 | 8:1 |
| | | | 49.4 | 9.9 | 5:1 |
| | | | 54.3 | 4.9 | 11:1 |
| | | | 56.4 | 2.8 | 20:1 |

Polyethylene glycols (PEG) have the following general formula:

H(OCH₂CH₂)ₙOH (1)

where the number n, the total number of ethylene oxide groups (repeating unit) in the molecule, is the degree of polymerization. The determining characteristic of any polyethylene glycol is its molecular weight (MW). The average molecular weight of polyethylene glycol (MW PEG) is calculated by multiplying the molecular weight of the ethylene oxide repeating unit (44 g/mol) by the degree of polymerization and adding the molecular weight of the end groups H and OH, thus 18 g/mol, according to the formula MW PEG (g/mol)=18 (g/mol)+n*44 (g/mol). For example, polyethylene glycols with a degree of polymerization of about 9 have an average molar mass of about 400, polyethylene glycols with a degree of polymerization of about 136 have an average molar mass of about 6,000, and polyethylene glycols with a degree of polymerization of about 172 have an average molar mass of about 12,000. Because polyethylene glycols are polymers, they may exist not as uniform chemical compounds, but rather as mixtures of very similar polymer homologues. According to the present embodiments, suitable polyethylene glycols may have a molecular weight of from about 200 to about 12,000, where the lower limit can be any of 205, 210, 220, 250 or 275, and the upper limit can be any of 7,000, 8,000, 9,000, 10,000 or 11,000, where any lower limit can be used with any upper limit.

Those of skill in the art of formulating pumpable slurried polymer compositions will recognize that given the benefit of this disclosure, it may be possible to optimize the nature and concentrations of the gelling agent, the stabilizer agent, and the solvent mixture to deliver pumpable formulations in various environments such as hot or cold climates, or operable with various types of pumping equipment, that allow when mixed in the appropriate brine and with specific additional additives, to obtain effective gravel packing and mud displacement fluids which may comply with the three criteria of biodegradation, bioaccumulation and aquatic toxicity as described above. For example, in one or more embodiments, a formulation may include a clarified xanthan gum as a gelling agent, diutan gum as a stabilizer agent, and mixtures of glycerol and polyethyleneglycol of molecular weight 6,000 as a solvent mixture, where all the chemical compounds may comply with the three criteria of biodegradation, bioaccumulation and aquatic toxicity as described above.

As noted above, wellbore fluids may be formulated by dispersing the slurried gelling agents (comprising the above described components) of the present disclosure in an aqueous base fluid. Specifically, the slurried gelling agent may be admixed with an aqueous base fluid in an amount sufficient to provide a desired viscosity to the wellbore fluid. In such embodiments, the slurried gelling agent may be present in the wellbore fluid in an amount that ranges from about 1 to 30 gallons/1000 gallons of wellbore fluid, or about 2 to 27 gallons/1000 gallons of wellbore fluid, or about 5 to 25 gallons/1000 gallons of wellbore fluid, or about 10 to 20 gallons/1000 gallons of wellbore fluid, or about 12 to 18 gallons/1000 gallons of wellbore fluid.

In various embodiments, the aqueous base fluids of the wellbore fluids of the present application may generally comprise a) fresh water, b) inorganic acids such as hydrochloric acid, hydrofluoric acid, hydrobromic acid, hydroiodic acid, hydrogen sulfide, nitric acid, sulfuric acid, phosphoric acid, carbonic acid, and the like, or c) organic acids such as methane sulfonic acid, formic acid, acetic acid, lactic acid, glycolic acid, erythorbic acid, citric acid, and the like, and d) soluble or insoluble salts thereof such as those obtained by neutralization of inorganic acids with alkali metal hydroxides, such as sodium, potassium, rubidium, or cesium, and the like, namely sodium chloride, sodium fluoride, sodium bromide, sodium iodide, sodium nitrate, sodium sulfate, sodium bisulfate, sodium sulfide, sodium carbonate, sodium hydrogen carbonate, or sodium bicarbonate, sodium hydrogen phosphate, sodium dihydrogen phosphate, or sodium phosphate, and the like; potassium chloride, potassium fluoride, potassium bromide, potassium iodide, potassium nitrate, potassium sulfate, potassium bisulfate, potassium sulfide, potassium carbonate, potassium hydrogen carbonate, or potassium bicarbonate, potassium hydrogen phosphate, potassium dihydrogen phosphate, or potassium phosphate, and the like; rubidium chloride, rubidium fluoride, rubidium bromide, rubidium iodide, rubidium nitrate, rubidium sulfate, rubidium bisulfate, rubidium sulfide, rubidium carbonate, rubidium hydrogen carbonate, or rubidium bicarbonate, rubidium hydrogen phosphate, rubidium dihydrogen phosphate, or rubidium phosphate, and the like; cesium chloride, cesium fluoride, cesium bromide, cesium iodide, cesium nitrate, cesium sulfate, cesium bisulfate, cesium sulfide, cesium carbonate, cesium hydrogen carbonate, or cesium bicarbonate, cesium hydrogen phosphate, cesium dihydrogen phosphate, or cesium phosphate, and the like; or e) soluble or insoluble salts thereof such as those obtained by neutralization of inorganic acids with alkali earth hydroxides, such as magnesium, calcium, strontium, or barium, and the like magnesium chloride, magnesium fluoride, magnesium bromide, magnesium iodide, magnesium nitrate, magnesium sulfate, magnesium sulfide, or magnesium phosphate, magnesium carbonate, magnesium bicarbonate and the like; calcium chloride, calcium fluoride, calcium bromide, calcium iodide, calcium nitrate, calcium sulfate, calcium sulfide, or calcium phosphate, calcium carbonate, calcium bicarbonate and the like; strontium chloride, strontium fluoride, strontium bromide, strontium iodide, strontium nitrate, strontium sulfate, strontium sulfide, or strontium phosphate, strontium carbonate, strontium bicarbonate and the like; barium chloride, barium fluoride, barium bromide, barium iodide, barium nitrate, barium sulfate, barium sulfide, or barium phosphate, barium carbonate, barium bicarbonate and the like; or f) soluble or insoluble salts thereof such as those obtained by neutralization of organic acids with alkali earth metal hydroxydes, such as sodium, potassium, rubidium, or cesium, such as sodium methane sulfonate, sodium formate, sodium acetate, sodium lactate, sodium glycolate, sodium erythorbate, sodium citrate, and the like; such as sodium methane sulfonate, sodium formate, sodium acetate, sodium lactate, sodium glycolate, sodium erythorbate, sodium citrate, and the like; such as potassium methane sulfonate, potassium formate, potassium acetate, potassium lactate, potassium glycolate, potassium erythorbate, potassium citrate, and the like; such as rubidium methane sulfonate, rubidium formate, rubidium acetate, rubidium lactate, rubidium glycolate, rubidium erythorbate, rubidium citrate, and the like ; such as cesium methane sulfonate, cesium formate, cesium acetate, cesium lactate, cesium glycolate, cesium erythorbate, cesium citrate, and the like; or g) soluble or insoluble salts thereof such as those obtained by neutralization of organic acids with alkali metal hydroxydes, such as magnesium, calcium, strontium, or barium, and the like; such as magnesium methane sulfonate, magnesium formate, magnesium acetate, magnesium lactate, magnesium glycolate, magnesium erythorbate, magnesium citrate, and the like; such as calcium methane sulfonate, calcium formate, calcium acetate, calcium lactate, calcium glycolate, calcium erythorbate, calcium citrate, and the like; such as strontium methane sulfonate, strontium formate, strontium acetate, strontium lactate, strontium glycolate, strontium erythorbate, strontium citrate, and the like; such as barium methane sulfonate, barium formate, barium acetate, barium lactate, barium glycolate, barium erythorbate, barium citrate, and the like, aluminum, iron, salts, or a combination thereof. Even though monovalent brines may optimize the retained permeability of the gravel pack, other water sources may be used, including those comprising monovalent, divalent, or trivalent cations (e.g., chromium, titanium, boron, aluminum, zinc, or iron) and, where used, may be of any concentration, density, or weight.

According to the present embodiments, the aqueous base fluids that have shown utility in the present disclosure have an acceptable health, safety and environmental profile. As noted above, the aqueous base fluids of the wellbore fluids of the present disclosure may generally comprise fresh water, salt water, sea water, a saturated brine (e.g., a saturated salt water or formation brine), a non saturated brine, or a combination thereof. Other water sources may be used, including those comprising monovalent, divalent, or trivalent cations (e.g., magnesium, calcium, zinc, or iron) and, when used, may be of any density, also commonly known as weight. Even though formulation optimization stages may be suitable to accommodate the rheological profile of the disclosed formulated fluid including the environmentally friendly slurried gelling agent of the present disclosure to the downhole lower completion, the use of the environmentally friendly aqueous wellbore fluid disclosed is not limited by wellbore design parameter such as the depth, type of wellbore, wellbore location, type of screen, wellbore size, type of completion (open hole or cased hole), the number of sections to be gravel packed, the type and choice of packers and gravel packing tools, the extent of formation fracturing potentially happening during the treatment, or any other completion parameter.

According to various embodiments, certain types of stabilizers (clay control agents) may be used which are typically added to the formulated gravel packing fluids or mud displacement fluids comprising the environmentally friendly slurried gelling agents as disclosed herein, to provide formation stability or integrity specifically to clay related issues such as clay dispersion, clay swelling, and clay disaggregation. The stabilizers that have shown utility in the present disclosure may be selected from the group of organic clay stabilizers, polymeric clay stabilizers, inorganic clay stabilizers and mixtures of thereof. In various embodiments, one or more clay stabilizers may also be included in the wellbore fluids of the present disclosure. Suitable examples include hydrochloric acid and chloride salts, such as sodium chloride, or potassium chloride, organic chloride salts such as tetramethylammonium chloride (TMAC), chloline chloride, other choline derivatives such as choline carbonate, choline bicarbonate, oligomeric cationic clay stabilizers, or amine containing oligomeric clay stabilizers, such as polyether amines, or polyetheramine salts. The amount of clay stabilizer used in the composition may vary upon the end use of the composition. For example, the clay stabilizer may be present in the formulated gravel packing fluids or mud displacement fluids that incorporate an environmentally friendly slurried gelling agent in an amount that ranges from about 0.001 wt % to about 3 wt %, or from about 0.2 wt % to about 1 wt % of the total weight of the fluid, where the lower limit can be any of 0.05 wt %, 0.06 wt %, or 0.07 wt % and the upper limit can be any of 2.8 wt %, 2.9 wt %, or 3 wt %, where any lower limit can be used with any upper limit.

It is also envisioned that wellbore fluids as described herein, such as gravel packing fluids or mud displacement fluids, may include pH buffering agents, such as agents capable of buffering at pH of about 8.0 or greater. Examples of such agents may include water-soluble bicarbonate salts, carbonate salts, phosphate salts, or mixtures thereof, among others. Buffering agents may be added to the formulated gravel packing fluids or mud displacement fluids including the environmentally friendly slurried gelling agents as disclosed herein in an amount from about 0.01 wt. % to about 1 wt. %, based upon the total weight of the fluid.

In various embodiments, other types of stabilizers, commonly known as thermal stabilizers may be added to the environmentally friendly slurried gelling agents disclosed herein, to slow the degradation of the gelling agent during storage and transportation. It is also envisioned that thermal stabilizers may be added to wellbore fluid formulated gravel packing fluids or mud displacement fluids that include the environmentally friendly slurried gelling agents disclosed herein during fluid preparation and the treatment downhole. Examples of thermal stabilizers include oxygen and radical scavengers, such as for example, organic monoalcohols (e.g., methanol, ethanol, propanol, isopropanol, butanol), inorganic stabilizers (such as alkali metal thiosulfate, such as sodium thiosulfate, and ammonium thiosulfate bisulfites, metabisulfites, and the like), other organic stabilizers such as phenothiazine, antioxidizers such as Irganox, or Irgafox or phenol, substituted phenols and polyphenols, like hydroquinone, diterbutyl phenol, tannic acid, and derivatives, and the like. In various embodiments, the concentration of thermal stabilizer in the fluid may range from about 0.01 wt % to about 2 weight %, from about 0.02 wt % to about 1.5 weight %, from about 0.05 wt % to about 1 weight %, from about 0.1 wt % to about 1 weight % of the thermal stabilizers based on the total weight of the fluid depending on the mixing energy, bottom hole static temperature, water and brine source, and fluid density and brine type.

It is also envisioned that aqueous wellbore fluids of the present disclosure may comprise an organoamino compound. Examples of suitable organoamino compounds may include tetraethylenepentamine (TEPA), triethylenetetramine (TETA), pentaethylenehexamine, triethanolamine (PEHA), and the like, or any mixtures thereof. When organoamino compounds are used in fluids described herein, they are incorporated at an amount from about 0.01 wt. % to about 2.0 wt. % based on total weight of the fluid.

In various embodiments, the wellbore fluids of the present disclosure may comprise other components, particularly depending on the type of operation in which the fluid will be used. For example, gravel may be included in fluids and methods of using the fluids, according to the present disclosure. Any gravel may be used, provided that it is compatible with the aqueous medium, the formation, the treatment fluid, and the desired results of the treatment. Such gravels may be natural or synthetic, coated, or may contain chemicals. In general, the gravel used may have an average particle size of from about 0.15 mm to about 2.5 mm, more particularly, but not limited to typical size ranges of about 0.25-0.43 mm, 0.43-0.85 mm, 0.85-1.18 mm, 1.18-1.70 mm, and 1.70-2.36 mm. Normally, the gravel may be present in the wellbore fluid in an amount that ranges from about 0.12 kg proppant added to each litre (L) of carrier fluid to about 3 kg gravel added to each litre (L) of carrier fluid. A commonly used scale for the determination of the gravel size is the mesh size. Typical gravels in use are 12/16 mesh, 16/18 mesh, 16/30 mesh, 18/30 mesh, 20/40 mesh, 30/50 mesh and the like. The selection of the gravel size is performed based on the grain size distribution of the downhole hydrocarbon bearing formation by methods known to those of skill in the art.

It is also envisioned that once the wellbore fluid has completed its main function, for instance once the gravel packing fluid has been pumped into the subterranean formation and the gravel has been placed, it is desirable to rapidly “break” the gel into a fluid having low viscosity so that it can be either pumped or produced from the formation through the wellbore. In this regard, conventional oxidizers, enzymes, acids or mixtures thereof may be used. Such breakers reduce the polymer's molecular weight by the action of an acid, an oxidizer, an enzyme, or mixtures thereof, or some combinations of these on the polymer itself. For example, in order to provide a predictable breaking time within relatively narrow limits, a breaker comprising a mild oxidizing agent may be used. Suitable oxidizing agents are ammonium persulfate, sodium persulfate, potassium persulfate, sodium chlorite, sodium hypochlorite, sodium bromate, and the like, and mixtures thereof Also breaker aids, like iron sulfate heptahydrate, triethanolamine, or sodium bisulfate can be added to the wellbore fluid formulation. The selection of the type and concentration of breaker and breaker aid is performed ahead of the treatment by means of lab experiments, and typically differs for fluids formulated with various concentrations of gelling agent, formulated in different brine density fluids, and to be used at different bottom hole static temperatures, and also depends on application and time frame of viscosity reduction and on customer preference for rate of clean-up. The breaker may be present in an amount of from about 0.1 to about 80 pounds per 1,000 gallons of aqueous liquid. At bottom hole temperatures below about 140° F. (60° C.), enzymes are generally used as breakers.

In one or more embodiments, the wellbore fluids of the present disclosure that incorporate an environmentally friendly slurried gelling agent when intended for use as gravel packing fluids may have a rheological profile (measured at 80 F (26.7° C.)) meeting the following approximately target viscosities, commonly known as the AllPAC reference, at the respective shear rates shown in Table 3 below:

TABLE 3

| Shear Rate (s⁻¹) | Viscosity (cP) |
|---|---|
| 3 | 1800 |
| 10 | 800 |
| 20 | 480 |
| 30 | 310 |
| 40 | 240 |
| 50 | 200 |
| 80 | 130 |
| 100 | 105 |
| 170 | 80 |
| 200 | 70 |
| 300 | 50 |
| 500 | 35 |
| 1000 | 20 |

Other rules of thumb for minimum and maximum viscosity specifications are common in the industry, with allowed values slightly lower (up to 30% lower) and slightly higher (up to 10% higher) than those listed in Table 2.

The wellbore fluids incorporating the gelling agents of the present disclosure are stable and meet the environmental requirements, as well as the desired rheology and filtration properties for application in completion operations such as gravel packing fluids, cleanout fluids, spacer fluids, water shut-off treatment, and the like.

In various embodiments, the aqueous base wellbore fluids of the present disclosure may be used for gravel packing applications, including open hole gravel packing such as low viscosity high rate water packs, or viscous fluid low rate gravel packing treatments. In one or more embodiments, the fluid may not have sufficient viscosity to suspend and carry the gravel during placement, but may provide enough friction reduction compared to the brine itself to actually allow for a higher rate to be pumped without risk for the completion, and thus allowing sufficient dynamic gravel transport. It is also envisioned that the fluid may have sufficient viscosity to suspend and carry the gravel during placement. Both friction reduction and viscosity are properties derived from the nature of the selected composition and concentration of the environmentally friendly slurried gelling agents disclosed herein, the brine composition and density, and the temperature and pressure of use amongst others.

As described herein, the term gravel packing fluid refers to an aqueous wellbore fluid present in the wellbore and/or used during a wellbore operation to complete a well. According to various embodiments, the aqueous wellbore fluid may include the environmentally friendly slurried gelling agents as disclosed herein. A gravel packing fluid is a fluid that includes gravel such as large grain sand mixed with a carrier fluid. Gravel packing fluid may provide for efficient deposition of gravel at or adjacent to the open hole to establish a fluid flow path between the wellbore and an unconsolidated formation. While a conventional gravel packing fluid may contain additives that are environmentally unfriendly, the gravel packing fluids of the present disclosure may have a favorable environmental rating in the North Sea as they contain environmentally friendly slurried gelling agents. For example, the water-based gravel packing fluids of the present disclosure may be classified as “Gold” with no substitution warning in UK, and “Yellow” in Norway and Denmark. According to various embodiments, the gravel packing fluids that include the environmentally friendly slurried gelling agents and the treatments of use thereof as described herein may exhibit certain performance characteristics to be able to meet the desired fluid requirements, such as fluid rheology, break profile with the help of a breaker at certain temperatures, sand suspension and compatibility with the formation fluids, resulting in effective high performance lower completions. According to various embodiments, the gravel packing fluids, both pad and solids laden stages may be formulated on the fly, or batch mixed with the environmentally friendly slurried gelling agents disclosed, depending on the rig space and equipment of choice. It is also envisioned that associated treatments such as the mud displacement and the spacer fluids used to clean the screen open hole annular space, may be effectively formulated with the same environmentally friendly gelling agents as disclosed herein, providing additional rig efficiencies.

In an open hole gravel packing operation there are up to three pumping stages where the use of the environmentally friendly aqueous wellbore fluids comprising an environmentally friendly slurried gelling agent as disclosed herein may be of use and interest: i) the mud displacement or mud removal operation leaving a completion fluid in the annulus, ii) the clean fluid gravel packing fluid pad that displaces the completion fluid at the gravel packing rate, and iii) the gravel containing slurried fluid that displaces the pad, and places the gravel in the annulus.

In the mud displacement or mud removal operation a clean viscosified and densified fluid is pumped to fill the annular space between screen and open hole wellbore with a clean fluid and to ensure that all drilling solids are removed from this annular space, allowing for the next stages of the gravel packing treatment to occur effectively. In this case, a clearly defined strategy is followed to ensure that the aqueous fluid pumped allows for effective displacement of the mud, leaving a water wet formation, and that this is done without fluid fingering through (e.g., a well-known fluid instability when two fluid of different density and viscosities are pumped in a displacement operation) including selecting the right aqueous fluid density, and viscosity in relation to the mud fluid density, and viscosity. In addition, depending on the nature of the mud, oil or water based, the mud displacement aqueous fluid pumped may comprise several different compositions with different densities, viscosities, and additives that enhance the mud displacement (such as surfactants, dispersants and or demulsifiers), and minimize the risk of contamination of the clean fluid to be left in the annulus in place of the existing drilling mud. This is the case of spacer fluids that can also be considered as sacrificial fluids. In this operation, several annular space volumes of the clean environmentally friendly aqueous wellbore fluid may be used to ensure that efficient mud displacement occurs, provided that the fluid is properly formulated to achieve the desired properties.

Pumping the clean fluid gravel packing fluid pad serves to establish the safety margins of the operation, to verify that the fluidic channels through the completion equipment are properly open, including the screen wellbore annulus, to evaluate any potential loses of fluid downhole, to ascertain the potential for formation fracturing, and to determine the downhole pressures to be obtained during the next stages of the treatment, what ultimately serves as a verification of the possible safe operating pumping rate window, provided that the fluid is properly formulated to achieve the desired properties.

Pumping the gravel containing fluid or slurried gravel packing fluid serves to place a specific amount of gravel in the annular space between a hole and a screen, in a compact pack that served the purpose of this sand control technique. This gravel placement may be performed exclusively through the annular space, or partially through alternate paths such as shunt tubes, and shroud-screen annulus provided that the fluid is properly formulated to achieve the desired properties.

In a cased hole gravel packing operation there are up to three pumping stages where the use of the environmentally friendly aqueous wellbore fluids comprising an environmentally friendly slurried gelling agent as disclosed herein may be of use and interest: iv) the wellbore kill pill used before, during or after the perforating stage of the cased hole, similarly to the openhole gravel packing treatment; v) the clean fluid gravel packing fluid pad that displaces the completion fluid at the gravel packing rate, and vi) the gravel containing slurried fluid that displaces the pad, and places the gravel in the annulus. The wellbore kill pill used before, during or after the perforating stage of the cased hole is used to prevent uncontrolled fluid losses to the formation. Such fluid is used to ensure that whilst there is fluidic communication between formation and cased hole, through the perforation tunnels (which should have by passed the drilling mud filter cake) the well is maintained in control during the lower completion and screen placement and during the gravel packing treatment.

Whilst various sources of xanthan material may be found in stock at off-shore rig sites, and in land warehouses which may deliver properties consistent with one or two of the operations described herein, the environmental profile of each source of polymer demands to be independently registered and recorded for off-shore operations. Often, the personnel onsite is unaware of changes in regulation, or chemical composition variations for the various products in use at the rig, and there is a certain risk for miscommunication resulting in the operator pumping non compliant products if products for exclusive use in land operations are transported into the off-shore facilities, some of which can be discharged into the sea bed and others which cannot be discharged. In other occasions, the rig personnel may not be aware of the specific performance characteristics, or such as retained permeability or cleanliness properties of the products, or their environmental profile for operations the products are intended to be used for.

Whereas the primary objective of the environmentally friendly slurried gelling agents disclosed herein is to provide a viscosified wellbore fluid that may serve as a pad fluid in a gravel packing treatment operation, and to provide a viscosified wellbore fluid that may suspend the gravel for use in a gravel packing treatment, it has been found that the use of the environmentally friendly slurried gelling agents of the present disclosure may also comply with a series of specifications in multiple operations. Wellbore operations where the fluids could be used are those such as fracturing treatments, mud displacement operations in casing-formation annuli preceding cementing operations, mud removal operations in casing-formation annuli preceding cementing operations, mud displacement operations in screen-formation annuli preceding gravel packing operations, mud removal operations in screen-formation annuli preceding gravel packing operations, prevention of viscous interface formation by use of spacer fluids in between mud and cement, viscosification of loss circulation pills, viscosification of drilling fluids such as water-based and or oil-based muds etc., prevention of viscous interface formation by use of spacer fluids in between mud and gravel packing fluid, formation fluid displacement in a matrix treatment, formation fluid displacement in a water control treatment, formation fluid displacement in a fracturing treatment as preflush, matrix or fracturing treatment diversion operations, wellbore clean-out operations, completion fluid for perforation, kill pill to prevent losses post perforation, viscous interface in a high density fluid formulation pill which is pumped in the wellbore or annulus to provide support to another treatment pill and the like. It is also envisioned that the environmentally friendly slurried gelling agents as disclosed herein may be used in other applications and wellbore operations where similar properties are of interest, such as solids transport, reduced friction, solid particulate suspension, high viscosity, low emulsion formation tendency, effective polymer degradation or break, and good gravel or formation retained permeability.

In open hole gravel packing operations, once the mud has been conditioned, the larger drill solids which could plug the screens are removed through circulation and filtration, and the screens are located in place, the remaining mud fluid (such as oil based mud, or water based mud) may be displaced from the annulus. This is a delicate operation, substantially impacting the success of the overall gravel packing treatment, not consistently considered as relevant as it should be, as it often concludes the drilling operations, and serves as temporary well abandonment until the gravel packing operation can resume. In the case of reservoirs drilled with non aqueous fluids (or oil base muds) these operations ensure that the fluid oil based mud is displaced, and the annulus is filled with a clean solids-less viscous dense fluid. In the case of reservoirs drilled with aqueous fluids (or water base muds), these operations ensure that the fluid water based mud is displaced, and the annulus is filled with a clean solids-less viscous dense fluid. In many occasions, this operation is performed by the drilling crew, whom is mostly familiar with the drilling and loss circulations chemical additives, but not with the stimulation or gravel packing chemical additives. Since the primary objective of a drilling fluid or a loss circulation pill is to ensure the continuity of the drilling process with no or minor interruptions, and preventing loss of fluid to the formation, filter cake creation to stop any fluid loss is the primary requirement for this application. Thus, fluid loss control capability is one of the primary performance objectives of the polymers in use at the rig during the drilling operation, and whereby the presence of insoluble mud filter cake forming materials is favored in their design. Unfortunately, ensuring that the fluid left in the wellbore would result in a high permeability porous space is not a priority for the drilling operation. Thus, removing the content of cellular debris, and other insoluble materials associated with non modified polysaccharides is not a priority for the polymers in use in off-shore rigs during drilling, and as such, the use of modified polymer products to prepare small control pill batches such as clarified xanthan is not frequently observed, or recommended, and it is often considered over engineered or overpriced.

On the other hand, once the well has been drilled, the nature of the gravel packing operation focuses on minimizing loss of potentially damaging fluid into the formation, thus yet controlling fluid loss, but this is achieved by minimizing the damage to the existing filtercake, and also ensuring that no debris plugs the screen, or the pores in between gravel grains in the annular space between screen and formation. For this, the fluid in use is free of insolubles, which can be enabled by ensuring that once the lower completion is in place, clean, clarified or modified products are used in mud displacement operations, spacers, gravel packing fluid pad stage, and gravel or sand containing gravel packing fluid slurry stages.

Thus, one advantage of the environmental gelling agent slurry disclosed herein is that it can be used in different stages of the lower completion operations, providing additional flexibility to the operation, and allowing for consolidation of inventory, and reducing the risk of miss-use of chemicals. For instance, the mud displacement operation involves the preparation of a given volume of fluid in a dense brine (at a density typically slightly different, higher or lower than that of the gravel packing fluid treatment) typically batch mixed, that often, because of unforeseen process events during the pumping stage, may or may not be sufficient to complete the mud displacement to the appropriate standard of annulus cleanliness (concentration of solids, turbidity) what may or may not result in a large volume of unused material. Batch mixing viscosifiers in brines, especially in heavy brines is a time and space consuming process, and most rigs do not have multiple tanks to spare for this operation. Excess batch mixed material prepared, but not finally used to complete the displacement, is typically disposed as it is deemed inappropriate for the gravel packing treatment. Also, situations where the rig time is decisive may result in the operator preventing a complete annular cleaning operation if the process involves the preparation of a new batch of fluid. The use of the environmental gelling agent slurry as disclosed herein may allow for “on the fly mixing”, that is a process encompassing continuous pumping of the slurry into the brine and simultaneous immediate polymer hydration, which is much more efficient (less time involved, higher viscosity yield per unit mass of polymer). Such a process may typically prevent the undesirable fish eyes that may form in batch mixing operations and may become a nuisance that involves longer mixing time, and that at times may be compensated with longer mixing periods under heavy shearing, or, in the worst case scenario may result in damaging plugging solids for the porous space in the gravel pack, and the sole fluid used for the operation is prepared, not more, not less. Also, even if the environmentally friendly slurried gelling agents of the present disclosure are batch mixed in a substantial excess, because they are a clarified material, their use in the mud displacement may not result in a potential damage to the screens or gravel packing treatment. The remaining fluid may be used typically by dilution with water as part of the gravel packing fluid pad stage, allowing for additional polymer to be added, to top up the concentration and viscosity as recommended, creating fluid efficiencies, and minimizing the need for fluid disposal.

Furthermore, the gravel packing fluid design takes weeks, if not months, or even years before the pumping operation at the rig happens. In this case, it is not possible to establish sufficiently accurately the amount of breaker used to effectively reduce the fluid viscosity upon completion of the treatment because of the potential contamination with an unknown source of debris from the viscosifier to be used during the mud displacement operation. Thus, the use of the same source of polymer in gravel packing treatment and mud displacement may result in a much better predictability of the breaker mass balance and may reduce the inventory of products brought to the rig as contingency permits a more predictable fluid viscosity reduction, and thus an effective optimization of the gravel pack retained permeability, and also ultimately a more efficient and economical operation. Therefore, it has been discovered that the use of the environmentally friendly slurried gelling agents disclosed herein may induce additional efficiency gains besides a reduction of the total chemical use for the operation, and ultimately lower footprint at the rig.

Upon mixing, the fluids of the present embodiments may be used in wellbore operations, such as stimulation, friction reduction, gravel packing operations or cementing operations (as spacer fluids), as described above. Such operations are known to persons skilled in the art and involve pumping a wellbore fluid into a wellbore through an earthen formation and performing at least one downhole operation while the wellbore fluid is in the wellbore.

One embodiment of the present disclosure involves a method of treating a subterranean formation penetrated by a wellbore. In one such an illustrative embodiment, the method involves pumping a wellbore fluid (such all of the embodiments described above) into the wellbore through the subterranean formation and performing a downhole operation. In a particular embodiment, the wellbore fluid may incorporate an aqueous base fluid and an environmentally friendly slurried gelling agent which may meet at least two of the environmental testing criteria, as defined above. In one or more embodiments, the wellbore operation may include treating the subterranean formation while the wellbore fluid is in the wellbore. For example, the wellbore operations may include any of the above described operations, including, but not limited to mud displacement, acting as a fluid spacer for two incompatible fluids, gravel packing pad fluid pumping stage, or gravel packing slurry placement stages.

It is also envisioned that the wellbore fluids of the present disclosure may be formulated using gravel and slurried gelling agents for a gravel packing operation. For example, a method of treating a subterranean formation penetrated by a wellbore may include pumping a wellbore fluid into the wellbore through the subterranean formation and treating the subterranean formation while the wellbore fluid is in the wellbore. While the fluid can include any of the above described embodiments, in a particular embodiment, the wellbore fluid may include an aqueous base fluid, gravel, and a slurried gelling agent which incorporates at least a gelling agent dispersed in a mixture of polyethylene glycol and glycerin.

In various embodiments, a method of gravel packing using multiple wellbore fluids may be used. In such an illustrative embodiment, the method of gravel packing an annulus between a screen and a subterranean formation penetrated by a wellbore involves pumping a first wellbore fluid into the wellbore to displace or remove mud from the annulus, temporarily leaving the wellbore fluid as a completion fluid in the annulus and pumping a second wellbore fluid as a gravel packing pad fluid into the wellbore, to displace the completion fluid from the annulus at a gravel packing rate, pumping a third wellbore fluid into the wellbore to displace the gravel packing fluid and place the third wellbore fluid as a gravel packing slurry in the annulus at a gravel packing rate. In such embodiment, the first and the second wellbore fluid may be identical or different, and may include an aqueous base fluid, and a slurried gelling agent including at least a gelling agent dispersed in a mixture of polyethylene glycol and glycerin. The third wellbore fluid may include an aqueous base fluid, gravel and a slurried gelling agent including at least a gelling agent dispersed in a mixture of polyethylene glycol and glycerin.

### EXAMPLES

The following examples are presented to further illustrate the preparation and properties of the wellbore fluids of the present disclosure and should not be construed to limit the scope of the disclosure, unless otherwise expressly indicated in the appended claims. Specifically, the feasibility of using environmentally friendly xanthan slurries as disclosed herein for well production and gravel pack operations in off-shore environmentally sensitive areas such as North Sea, Angola, French Guyana, Canada, Australia, etc. and other countries like Germany has been evaluated.

Xanthan-based slurries were used to formulate gravel packing fluids for well production and gravel pack applications in downhole formations intersected by wellbores. For example, two slurried gelling agents containing Chemicals A and B, respectively, were used to prepare various gravel packing fluids. Chemical A is a standard environmentally unfriendly xanthan gum based slurry which is currently used in well production and gravel pack applications, and Chemical B is an environmentally friendly alternative to Chemical A. Specifically, both Chemicals A and B include the same powdered clarified xanthan polymer, slurried in an inert solvent. As defined herein, an inert solvent is a solvent that does not cause chemical reactions. The main difference between Chemical A and Chemical B relies in the solvent formulation used, and the method to achieve a suitable stable slurry from the powdered xanthan polymer. Chemical B, which has an environmentally friendly profile, includes a mixture of PEG and glycerin. The solvent formulation used to slurry the powdered xanthan polymer in Chemical A is DPM glycol ether, which is considered as environmentally unfriendly in the Norwegian sector of the North Sea. In addition, Chemical B includes a minor concentration (about 0.5 wt %) of diutan gum as a stabilizer, whereas in Chemical A the xanthan is self-stabilized. The xanthan polymer content of Chemical A is approximately 42 wt % active xanthan polymer, while that of Chemical B is approximately 38 wt % active xanthan polymer. The combination of xanthan as a gelling agent, diutan as a stabilizer and PEG/glycerin as an environmentally friendly solvent results in an environmentally friendly formulation, which has a favorable rating for operations performed in the North Sea.

A comparative performance analysis of Chemicals A and B was performed by evaluating the rheological and environmental properties of the gravel packing fluids prepared at different densities in monovalent brines at different temperatures. Various fluid formulations were prepared using potassium chloride (KCl), sodium chloride (NaCl), sodium chloride and potassium chloride mixtures NaCl/KCl, and caesium formate (CsForm). The formulations and the type of results presented in the various figures for the tests are presented below in Table 4.

TABLE 4
Test matrix

| | Brine Type- | | | | |
|---|---|---|---|---|---|
| FIG. | Density | Temperature | Chemical A | Chemical B | Chemical C |
| 1 | KCl | 175° F. | Linear gel | | |
| | 9.7 lbm/gal | (79° C.) | 15 mL/L | | |
| | [1.16 SG] | | (15 gal/1000 gal) | | |
| 2 | KCl | 175° F. | | Linear gel | |
| | 9.7 lbm/gal | (79° C.) | | 15 mL/L | |
| | [1.16 SG] | | | (15 gal/1000 gal) | |
| 3 | KCl | 175° F. | Break profile. 15 mL/L | Break profile. 15 mL/L | |
| | 9.7 lbm/gal | (79° C.) | (15 gal/1000 gal) | (15 gal/1000 gal) | |
| | [1.16 SG] | | fluid with 20 lbm/ | fluid with 20 lbm/ | |
| | | | 1000 gal breaker | 1000 gal breaker | |
| 4 | NaBr | 175° F. | Linear gel | | |
| | 10.0 lbm/gal | (79° C.) | 15 mL/L | | |
| | [1.19 SG] | | (15 gal/1000 gal) | | |
| 5 | NaBr | 175° F. | | Linear gel | |
| | 10.0 lbm/gal | (79° C.) | | 15 mL/L | |
| | [1.19 SG] | | | (15 gal/1000 gal) | |
| 6 | NaBr | 175° F. | Break profile. 15 mL/L | Break profile. 15 mL/L | Break profile 15 mL/L |
| | 10.0 lbm/gal | (79° C.) | (15 gal/1000 gal) | (15 gal/1000 gal) | (15 gal/1000 gal) |
| | [1.19 SG] | | fluid with 30 lbm/ | fluid with 30 lbm/ | fluid with 30 lbm/ |
| | | | 1000 gal breaker | 1000 gal breaker | 1000 gal breaker |
| 7 | NaBr | 207° F. | Break profile 15 mL/L | Break profile 15 mL/L | |
| | 11.4 lbm/gal | (97° C.) | (15 gal/1000 gal) | (15 gal/1000 gal) | |
| | [1.36 SG] | | fluid with 20 lbm/ | fluid with 20 lbm/ | |
| | | | 1000 gal breaker | 1000 gal breaker | |
| 8 | NaBr/KCl | 225° F. | Break profile. 17.5 mL/L | Break profile. 17.5 mL/L | |
| | 11.5 lbm/gal | (107° C.) | (17.5 gal/1000 gal) | (17.5 gal/1000 gal) | |
| | [1.37 SG] | | fluid with 15 lbm/ | fluid with 15 lbm/ | |
| | | | 1000 gal breaker | 1000 gal breaker | |
| 9 | NaBr | 250° F. | Break profile. 22.5 mL/L | Break profile. 22.5 mL/L | Break profile. |
| | 12.0 lbm/gal | (121° C.) | (22.5 gal/1000 gal) | (22.5 gal/1000 gal) | 22.5 mL/L |
| | [1.44 SG] | | fluid with 10 lbm/ | fluid with 10 lbm/ | (22.5 gal/1000 gal) |
| | | | 1000 gal breaker | 1000 gal breaker | fluid with 10 lbm/ |
| | | | | | 1000 gal breaker |
| 10 | CsForm | 350° F. | Linear gel 25 mL/L | Linear gel 25 mL/L | |
| | 16.0 lbm/gal | (176° C.) | (25 gal/1000 gal) | (25 gal/1000 gal) | |
| | [1.91 SG] | | | | |

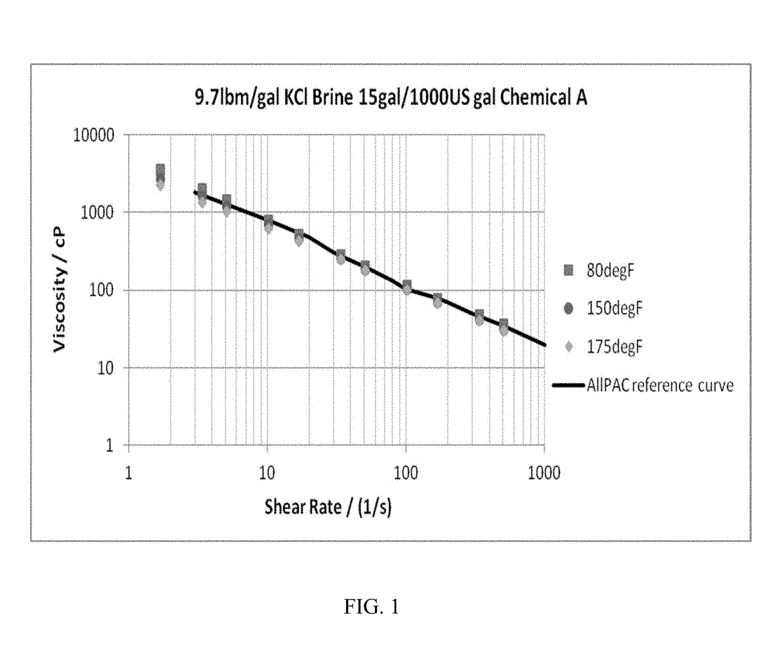

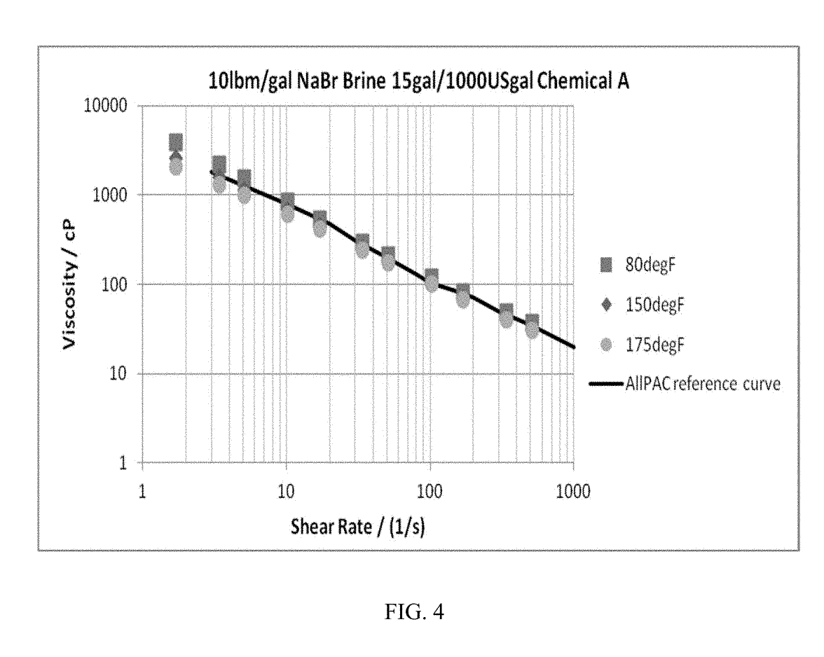

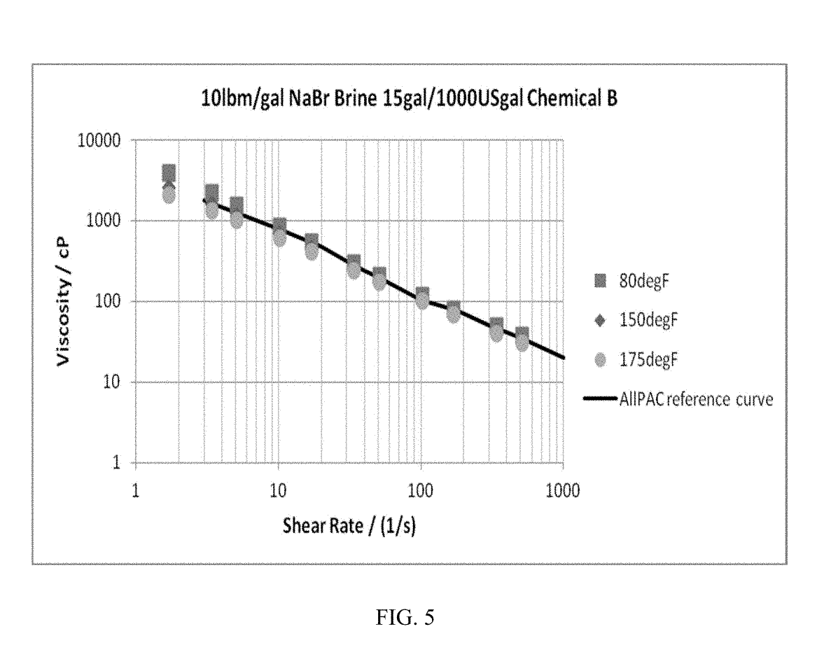

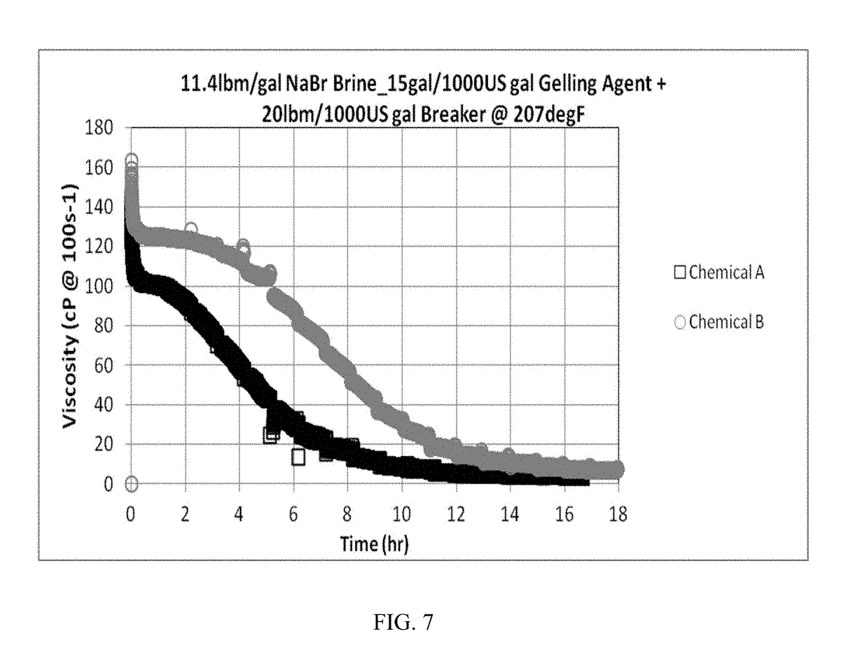

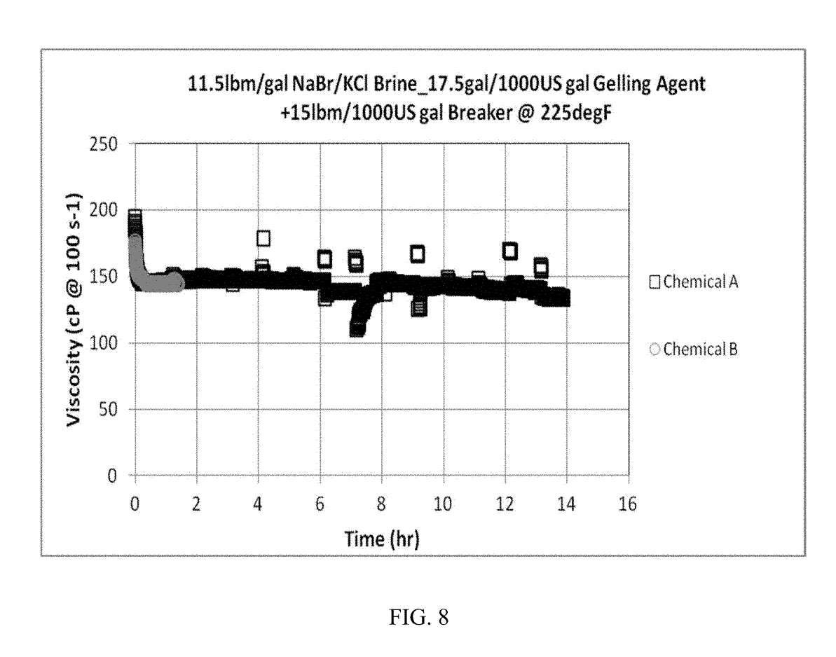

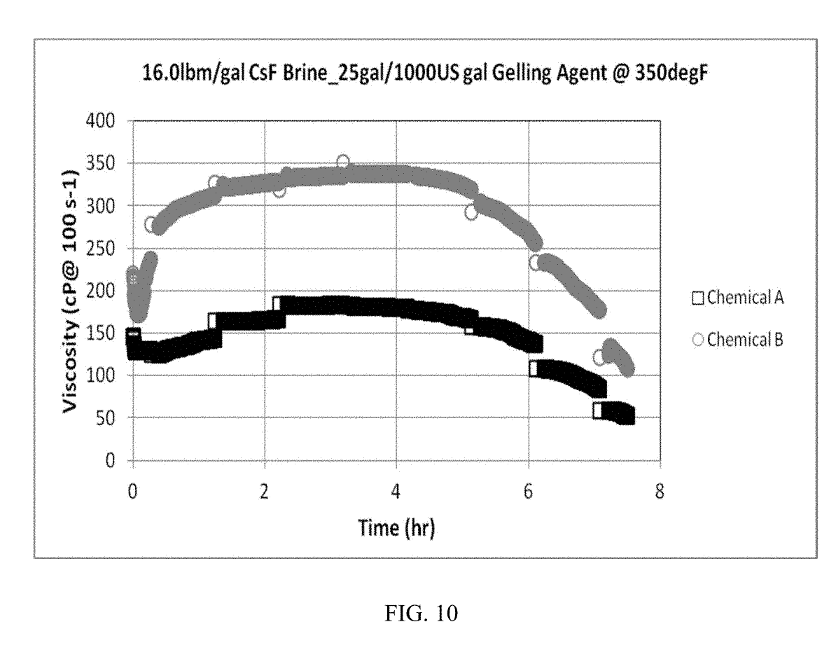

Oxidative breakers were used in the break profile tests up at 175° F. (79° C.), 207° F. (97° C.) and 250° F. (121° C.) and no breaker was used at 350° F. (176° C.). While performing tests with oxidative breakers, the polymer was hydrated and its rheology was measured using a Chandler 35 rheometer at room temperature. The linear gel viscosity profile was also determined with a Chandler 5550 rheometer at different temperatures, and these results are reported. Specifically, once the polymer was hydrated, oxidative breaker solutions in water were added to the hydrated polymer slurry according to the specific stability time frame and reservoir temperature, and afterwards the mixture was tested at the desired temperature and 500 psi with a Chandler 5550 rheometer. The polymer linear gel and break profiles comparison of environmentally friendly and environmentally unfriendly xanthan slurries are shown in FIGS. 1-10.

Sand suspension tests, which are common for gravel pack fluids, were carried out to determine the sand settling behavior in a static condition at bottom hole temperature. The results of the sand suspension tests are presented in Table 5 below. Based on the results, the maximum pumping shut down period may be determined. According to the industry guideline, settling of less than 20% is accomplished in 30 minutes.

TABLE 5
Sand suspension test results

| | | Sand Suspension | |
|---|---|---|---|
| | | (% settling after 30 mins) | |
| Brine Formulation | Temperature | Chemical A | Chemical B |
| KCl 9.7 lbm/gal | 175° F. (79° C.) | 15 | 1 |
| (1.16 SG) | | | |
| NaBr 10.0 lbm/gal | 175° F. (79° C.) | 1 | 0 |
| (1.19 SG) | | | |
| NaBr 11.4 lbm/gal | 207° F. (97° C.) | — | 3 |
| (1.36 SG) | | | |
| NaBr/KCl 11.5 | 225° F. (107° C.) | 1 | 2 |
| lbm/gal | | | |
| (1.37 SG) | | | |

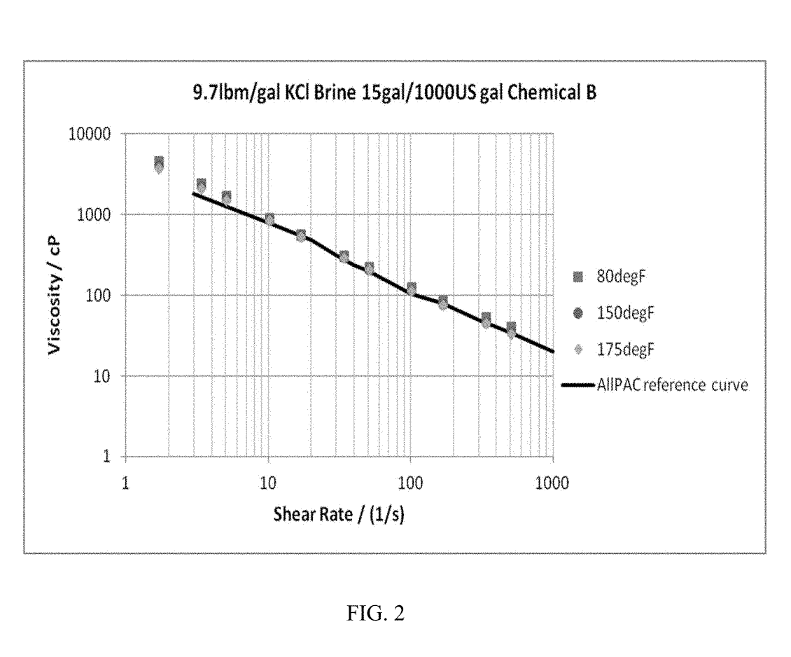

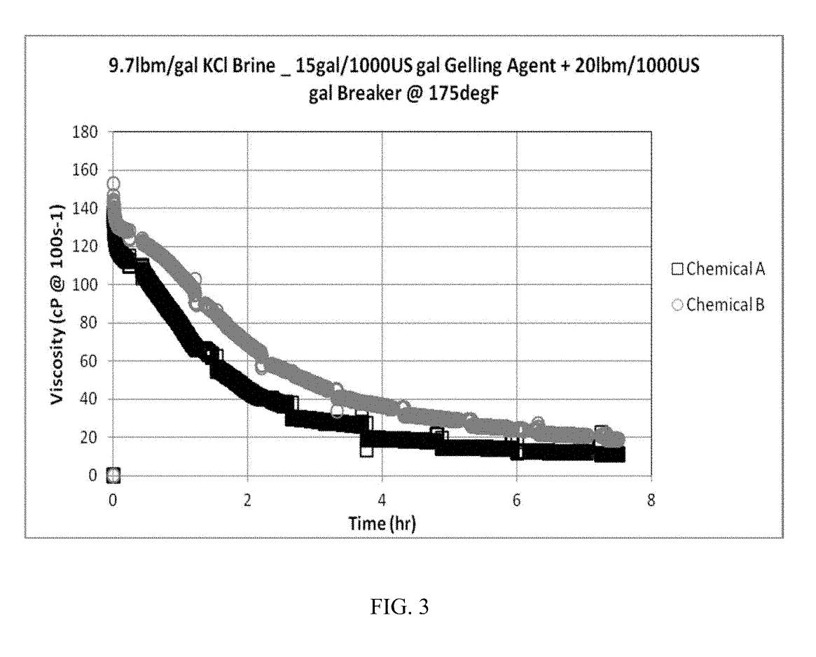

The comparison of different polymer concentrations with various types of brines at different temperatures, as shown in FIGS. 1-10, provides evidence of a better rheological performance of Chemical B compared to Chemical A. Specifically, the linear gel at 15 mL/L concentration of chemical B demonstrates higher low shear viscosity (FIG. 2), compared to Chemical A (FIG. 1), which clearly translates into better effectiveness of sand suspension (15 vol % settling with Chemical A vs. 1 vol %. settling with Chemical B). At other densities, the effect is negligible, indicating that both products exhibit excellent sand suspension. In addition, as seen in FIGS. 1, 2, 4 and 5, the linear gel viscosity for both fluid formulated with Chemical A and Chemical B are compared with a viscosity guideline curve (named AllPAC reference curve, as noted above) established for gravel pack fluids and accepted in industry. As seen in FIGS. 1, 2, 4 and 5, the linear gel viscosity for both fluids formulated with Chemical A and Chemical B are all acceptable. Furthermore, as seen in FIGS. 3, 6, 7 8, 9 and 10, Chemical B exhibits a better break profile compared to Chemical A (with the same concentration of breaker it takes a longer period of time to break, which allows for a better deal of flexibility during the treatment).

These results are unexpected as Chemical B contains a lower concentration of the gelling agent compared to Chemical A. Specifically, while the active xanthan polymer loading in Chemical A is higher than in Chemical B, namely 4 lbm/gallon US for Chemical A versus 3.6 lbm/gallon US for Chemical B, (concentrations calculated based on the active weight percent of gelling agent in the slurry as per above) the experimental data indicates that the environmentally friendly Chemical B has a substantially higher viscosity than that of its counterpart A, and that this viscosity can be maintained more effectively even in the presence of oxidative breakers. This is supported by the higher viscosity values at time 0 minutes as seen in FIGS. 3, 6, 7 and 9. Thus, when Chemicals A and B are tested for same concentration of mL slurry chemical/L fluid or same gallons Chemical/1000 gallons fluid, the viscosity is higher for Chemical B than for Chemical A. Moreover, when fluids with the same viscosity are prepared, this may be achieved with a lower concentration of Chemical B than that of Chemical A in mL chemical/L fluid or in gallons Chemical/1000 gallons fluid. This may be advantageous in gravel packing treatments, since lower polymer loading is known to typically result in improved clean properties for the fluid within the reservoir.

As seen from the experimental data depicted in FIGS. 1-10, and reported in Table 4, the viscosity profile at different temperatures and, as a consequence, the proppant sedimentation tests, confirm the effectiveness of Chemical B as an environmentally friendly slurried gelling agent under various operational conditions. Moreover, Chemical B may be used as an environmentally improved replacement of the environmentally unfriendly Chemical A, with the additional benefit of having an improved viscosity development effectiveness.

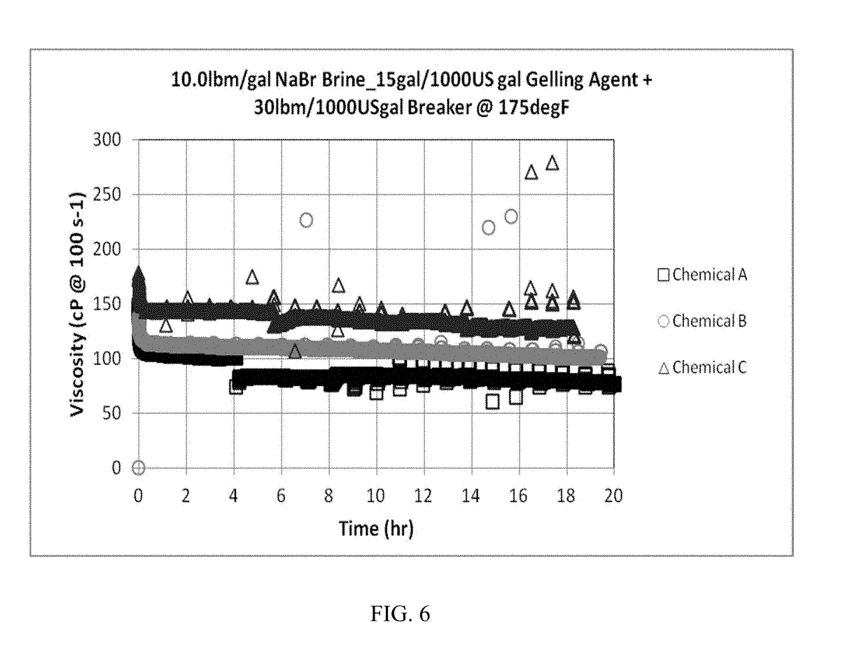

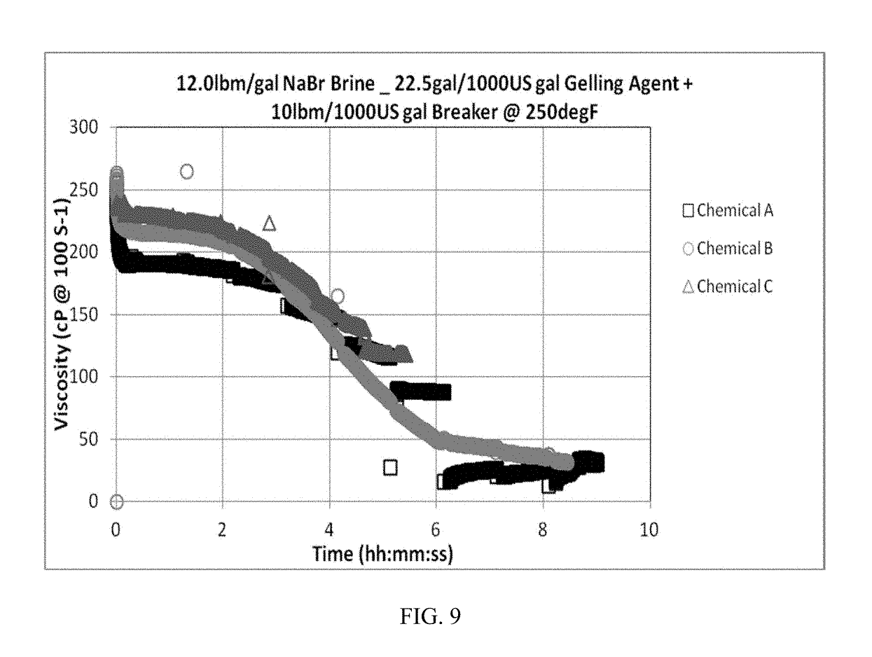

In order to further demonstrate the improved rheology of the environmentally friendly fluids as described herein, a third formulation was prepared using an environmentally friendly Chemical C which has the same environmentally acceptable solvent mixture and the same slurry stabilizer formulation (type of chemicals and concentrations) as Chemical B, but has a slightly different preparation method. Specifically, the xanthan polymer used was of a different source (slightly different bacterial strain, and slightly improved clarification method, as both processes are carried out in different chemical plants. Table 6 below summarizes a compositional comparison of the Chemicals A, B and C. The experiments performed with Chemical C are described in Table 4. Chemical C was found to have an even higher bulk polymer viscosity compared to both Chemicals A and B. As seen from the viscosity plots and the break profile of Chemical C shown in FIGS. 6 and 9, Chemical C outperforms Chemicals A and B.

TABLE 6
Comparison of Chemicals A, B and C

| Product | Formulation | Comments |
|---|---|---|
| Chemical A | Xanthan Polymer | Environmentally friendly |
| | | chemical |
| | DPM glycol ether | Environmentally unfriendly |
| | Solvent | chemical |
| Chemical B | Xanthan polymer | Environmentally friendly |
| | | chemical |
| | PEG-300/Glycerin | Environmentally friendly |
| | | chemical |
| | Diutan polymer | Environmentally friendly |
| | | chemical |
| Chemical C | Xanthan polymer | Environmentally friendly |
| | | chemical |
| | PEG-300/Glycerin | Environmentally friendly |
| | | chemical |
| | Diutan polymer | Environmentally friendly |
| | | chemical |

Without being bound by the theory, the inventors of the present disclosure believe that the improved viscosity performance of environmentally friendly fluids formulated with Chemicals B and C and including a lower concentration of xanthan gelling agent, a lower total polymer concentration, and a different solvent and slurry stabilizer polymer compared to Chemical A, is derived from a synergy between the selected gelling agent, stabilizer and the solvent package.

Advantageously, embodiments of the present disclosure provide wellbore fluids and methods for treating a wellbore with such fluids that include an aqueous base fluid, and an environmentally friendly slurried gelling agent. As demonstrated by the experimental data, the introduction of an environmentally enhanced slurry package (solvent and stabilizer) used as a polymer delivery slurry for wellbore operations results in an unexpectedly improvement in the viscosity of the wellbore fluids at a lower concentration of the gelling agent compared to conventional slurried gelling agents. The fluids disclosed herein are useful as gravel packing fluids, or in a stimulation, friction reduction or matrix acidizing operations, gravel packing operations or cementing operations (as spacer fluids). As noted above, the wellbore fluids disclosed herein are useful in fracturing treatments, mud displacement operations in casing-formation annuli preceding cementing operations, mud removal operations in casing-formation annuli preceding cementing operations, mud displacement operations in screen-formation annuli preceding gravel packing operations, mud removal operations in screen-formation annuli preceding gravel packing operations, prevention of viscous interface formation by use of spacer fluids in between mud and cement, viscosification of loss circulation pills, viscosification of drilling fluids such as water-based and or oil-based muds etc., formulation of perforation fluids, formulation of kill pill fluids, prevention of viscous interface formation by use of spacer fluids in between mud and gravel packing fluid, formation fluid displacement, treatment diversion operations, wellbore clean-out operations, viscous interface in a high density fluid formulation pill which is pumped in the wellbore or annulus to provide support to another treatment pill and the like.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed:

1. A method of treating a subterranean formation penetrated by a wellbore, the method comprising:
pumping a wellbore fluid into the wellbore, the wellbore fluid comprising:
an aqueous base fluid; and
an environmentally friendly slurried gelling agent meeting at least two of the following three criteria:
(1) Biodegradation
a) >60% in 28 days as measured by OECD 306 or any other OSPAR-accepted marine protocols,
b) or in the absence of valid results for such tests:
i. >60% in 28 days as measured by OECD 301B, 301C, 301D, 301F, 310, Freshwater BODIS or
ii. >70% in 28 days as measured by OECD 301A, 301E;
(2) Bioaccumulation
a) a bioconcentration factor of less than 100;
b) log P_{ow}≦3 and molecular weight >700, or
c) if the conclusion of a weight of evidence expert judgment under Appendix 3 of OSPAR Agreement 2008-5 is positive; and
(3) Aquatic Toxicity
a) LC₅₀>10 mg/l or EC₅₀>10 mg/l; and
performing a downhole operation.

2. The method of claim 1, wherein the environmentally friendly slurried gelling agent includes at least a gelling agent dispersed in a solvent with a stabilizer, wherein the gelling agent, the solvent and the stabilizer are environmentally friendly.

3. The method of claim 2, wherein the gelling agent is present in the environmentally friendly slurried gelling agent in an amount that ranges from about 30 wt % to 50 wt %.

4. The method of claim 1, wherein the environmentally slurried gelling agent is present in the wellbore fluid in an amount that ranges from about 1 to about 30 gallons per 1000 gallons of wellbore fluid.

5. The method of claim 1, wherein the environmentally slurried gelling agent is present in the wellbore fluid in an amount that ranges from about 10 gallons to about 20 gallons per 1000 gallons of wellbore fluid.

6. The method of claim 2, wherein the gelling agent is selected form the group of of xanthan gum, diutan gum, wellan gum, gellan gum, scleroglucan, schizophyllan, starch, natural galactomannans, synthetically modified guar derivatives, and cellulose derivatives.

7. The method of claim 1, wherein the environmentally friendly slurried gelling agent has a viscosity of at least 15 cP and a viscosity of less than 50 cP measured at a shear rate of 170s⁻¹.

8. The method of claim 1, wherein the environmentally friendly slurried gelling agent has a viscosity of at least 25 cP and a viscosity of less than 40 cP measured at a shear rate of 170s⁻¹.

9. The method of claim 2, wherein the solvent is selected from the group of polyethylene glycols, glycerin and mixtures thereof.

10. The method of claim 9, wherein the solvent is a mixture of polyethylene glycol and glycerin and wherein the ratio between polyethylene glycol and glycerin ranges from about 5:1 to about 20:1.

11. The method of claim 10, wherein the polyethylene glycol has a molecular weight ranging from 200 to about 12,000.

12. The method of claim 11, wherein the polyethylene glycol has a molecular weight ranging from about 275 to about 7,000.

13. The method of claim 2, wherein the stabilizer is selected from the group of organic stabilizers, inorganic stabilizers and mixtures thereof.

14. The method of claim 13, wherein the stabilizer is present in the environmentally friendly slurried agent in an amount that ranges from about 0.001 wt % to about 3 wt %.

15. The method of claim 1, wherein the method of treating a subterranean formation is comprises at least one method selected from: fracturing treatments, mud displacement operations in casing-formation annuli preceding cementing operations, mud removal operations in casing-formation annuli preceding cementing operations, mud displacement operations in screen-formation annuli preceding gravel packing operations, mud removal operations in screen-formation annuli preceding gravel packing operations, prevention of viscous interface formation by use of spacer fluids in between mud and cement, viscosification of loss circulation pills, viscosification of drilling fluids, prevention of viscous interface formation by use of spacer fluids in between mud and gravel packing fluid, formation fluid displacement in a matrix treatment, formation fluid displacement in a water control treatment, formation fluid displacement in a fracturing treatment as preflush, matrix or fracturing treatment diversion operations, wellbore clean-out operations, completion fluid for perforation, kill pill to prevent losses post perforation, or viscous interface in a high density fluid formulation pill which is pumped in the wellbore or annulus to provide support to another treatment pill.

16. A method of treating a subterranean formation penetrated by a wellbore, the method comprising:
pumping a wellbore fluid into the wellbore, the wellbore fluid comprising:
an aqueous base fluid;
gravel; and
a slurried gelling agent including at least a gelling agent dispersed in a mixture of polyethylene glycol and glycerin; and
treating the subterranean formation while the wellbore fluid is in the wellbore.

17. The method of claim 16, wherein the gelling agent is present in the slurried gelling agent in an amount that ranges from about 30 wt % to 50 wt %.

18. The method of claim 16, wherein the ratio between polyethylene glycol and glycerin ranges from about 5:1 to about 20:1.

19. The method of claim 16, wherein the wellbore fluid further comprises at least one breaker selected from an acid, an oxidizer, or an enzyme, or mixtures thereof.

20. The method of claim 19, wherein the breaker is a mild oxidizing breaker agent selected from ammonium persulfate, sodium persulfate, potassium persulfate, sodium chlorite, sodium hypochlorite, sodium bromate, and the like, and mixtures thereof.

21. The method of claim 16, wherein the method comprises:
pumping a first wellbore fluid into the wellbore to displace or remove mud from an annulus, temporarily leaving the wellbore fluid as a completion fluid in the annulus, the first wellbore fluid comprising:
an aqueous base fluid; and
a slurried gelling agent including at least a gelling agent dispersed in a mixture of polyethylene glycol and glycerin;
pumping a second wellbore fluid as a gravel packing pad fluid into the wellbore, to displace the completion fluid from the annulus at a gravel packing rate, the second wellbore fluid comprising:
an aqueous base fluid; and
a slurried gelling agent including at least a gelling agent dispersed in a mixture of polyethylene glycol and glycerin; and
pumping a third wellbore fluid into the wellbore to displace the gravel packing pad fluid and place the third wellbore fluid as a gravel packing slurry in the annulus at a gravel packing rate, the third wellbore fluid comprising:
an aqueous base fluid;
gravel, and
a slurried gelling agent including at least a gelling agent dispersed in a mixture of polyethylene glycol and glycerin.

22. An environmentally friendly slurried gelling agent chemical composition comprising at least a gelling agent dispersed in a solvent with a stabilizer, wherein each of the gelling agent, the solvent and the stabilizer are environmentally friendly, meeting at least two of the following three criteria:
(1) Biodegradation
a) >60% in 28 days as measured by OECD 306 or any other OSPAR-accepted marine protocols,
b) or in the absence of valid results for such tests:
i. >60% in 28 days as measured by OECD 301B, 301C, 301D, 301F, 310, Freshwater BODIS or
iii. >70% in 28 days as measured by OECD 301A, 301E;
(2) Bioaccumulation
a) a bioconcentration factor of less than 100;
b) log P_{ow}≦3 and molecular weight >700, or
c) if the conclusion of a weight of evidence expert judgment under Appendix 3 of OSPAR Agreement 2008-5 is positive; and
(3) Aquatic Toxicity
a) LC₅₀>10 mg/l or EC₅₀>10 mg/l.

23. An environmentally friendly wellbore fluid comprising:
an aqueous base fluid; and
the environmentally friendly slurried gelling agent chemical composition of claim 22.
